(19) United States
(12) Patent Application Publication
(10) Pub. No.: US 2009/0109842 A1
(43) Pub. Date: Apr. 30, 2009

(54) Device Manager Having Authoritative Process Relations For Conforming State Data Upon Failover

(76) Inventors: John R. Reilly, Roseville, CA (US); Robert L. Faulk, JR., Roseville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/929,954

(22) Filed: Oct. 30, 2007

(51) Int. Cl. H04L 12/24; G06F 11/07

(52) U.S. Cl. 370/220; 714/15

(57) ABSTRACT

A device has first and second instances of a computer-executable manager. When a failure is detected in the first instance while it is active, the second instance is activated. During activation of the second instance, a conforming first process of the second instance conforms its state data to an authoritative second process of the second instance.

### BACKGROUND OF THE INVENTION

The present invention provides a more highly available network switch. A network switch is a multi-port network interconnect device that forwards received packets to their intended destinations. Unlike a network hub, which broadcasts a received packet out all ports, a switch inspects a packet to determine its destination and then forwards it out only the port or ports that lead to its intended destination.

Modular switches allow for repair or expansion by inserting additional modules, e.g., into a chassis, or replacing defective or outdated modules; often the switches provide for “hot swapping”, i.e., removal or insertion while the switch is in operation to minimize downtime. Heterogeneous modular switches employ different types of modules. For example, a switch can employ 1) connectivity modules that provide the ports for connecting to an external network or networks, 2) fabric modules that provides internal connections among the ports, and 3) management modules. Most data packets are received at a port of a connectivity module and forwarded to a fabric module. The fabric module processes the data packet and forwards it to the appropriate port of a connectivity module for transmission to the packet's destination. A fabric module can route packets destined for the switch itself and packets needing special handling to the management module. For example, communications used to set up communication protocols are sent to management modules.

To avoid catastrophic network failures, several levels of redundancy are applied to the switching function. Multiple switches can be used to provide alternate network paths to bypass a failed switch. In addition, several types of redundancy can be applied to a switch to minimize the likelihood of it failing. At the connectivity level, multiple connections between a switch and a network node can remove the dependency on any single port or connectivity module. At the fabric level, redundant fabric modules can be used, and redundancy can be built into each fabric module.

At the connectivity and fabric levels, additional modules can be used not only to increase performance, but to provide back up in the event a module fails. At the management level, typically only one module can be active at a time; however, redundancy can be implemented in the form of a “tracking” standby module, i.e., a module that does not interact with external devices other than to track the state of an active module. In the event of a failure of the active module, the tracking standby module provides service continuity as it assumes management activities. However, there are situations in which the failover to the standby management module does not provide complete tracking of the state of the active module.

Herein, related art is described to facilitate understanding of the invention. Related art labeled “prior art” is admitted prior art; related art not labeled “prior art” is not admitted prior art.

### BRIEF DESCRIPTION OF THE DRAWINGS

The figures depict implementations/embodiments of the invention and not the invention itself.

FIG. 1 is a schematic diagram of a switch in accordance with an embodiment of the invention.

FIG. 2 is a flow chart of a method in accordance with an embodiment of the invention.

### DETAILED DESCRIPTION

In the course of the present invention, it was recognized that a failure of an active management (device-manager) module can leave a standby management module in a problematic state. In response to an event (e.g., receipt of a data packet in the process of establishing a communications protocol), an active management module can run several processes (herein, including threads and tasks), i.e., sequences of instructions being executed. To achieve high performance, these processes run concurrently and use respective local copies of common data. Once response processing is complete and all processes have reached steady state, a single consistent state is established for the active management module.

However, while a management module is responding to an event, the copies of data owned by different processes can become inconsistent. Likewise, the state of the standby management module, which is tracking the active management module, can be temporarily inconsistent. If the active management module fails when the standby management module is in an inconsistent state, the latter may fail to function properly when it assumes the role of the active management module.

To address this problem, the present invention provides for establishing authority relationships among management processes. During the transition from a standby mode to an active mode, the data associated with some “authoritative” processes is deemed “authoritative”. The data associated with non-authoritative processes or less authoritative processes is reconciled with more authoritative data to ensure a consistent state when active mode is assumed.

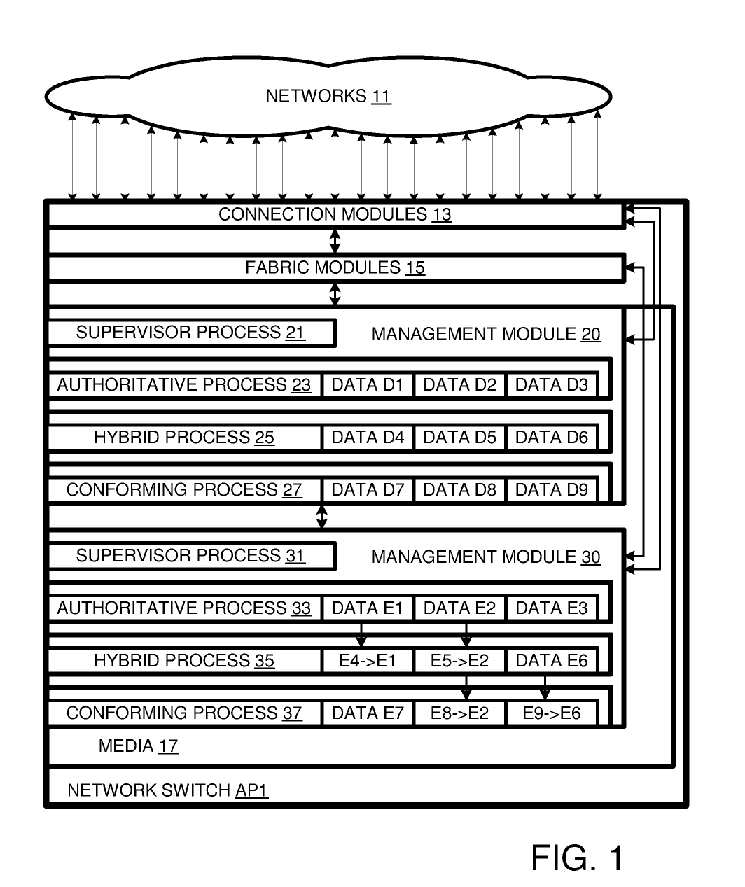

In FIG. 1, a network switch API in accordance with an embodiment of the invention provides switching or routing among nodes in networks 11. Plural connection modules 13 provide ports for the physical connections to networks 11. The invention applies to systems with one or more connection modules; plural connection modules can be used to provide redundancy and additional capacity. Most network traffic is routed internally between ports of connection modules 13 by fabric modules 15. The invention provides for any counting number of fabric modules, with plural modules being used for additional throughput and/or redundancy.

Network switch API, as illustrated in FIG. 1, has two management modules 20 and 30; these are programs of computer-executable instructions stored in computer-readable media 17. The invention requires active and standby management units. However, these can reside on the same or different (as in the embodiment of FIG. 1) physical modules. Additional management units can be provided for greater redundancy; in such a case there can be one active unit and the rest can be standby management units.

Management module 20 provides for concurrent software processes 21, 23, 25, and 27. Authority relations are established among processes 23, 25, and 27. Authoritative process 23 has top-level authority in that its data is authoritative and is not conformed to the data of any other process of management module 20. (Herein, process A “conforms” to process B when first data associated with process A and inconsistent with second data associated with process B is replaced by third data consistent with the second data.) The data can include layer 2 and layer 3 addresses as well as configuration data for processes and modules comprising the network switch.

Hybrid process 25 is both an authoritative process (with respect to process 27) and a conforming process (with respect to process 23). Process 25 is subordinate to authoritative process 23 in that the data of hybrid process 25 must conform or be conformed to the data of authoritative process 23. Conforming process 27 is at the receiving end of authority relations, its data must conform to that of hybrid process 25. Supervisor process 21 sequences activation of processes 23-27 so that authoritative data is available to conforming processes as the latter are activated.

Management module 30 is essentially identical to management module 20; management modules 20 and 30 are two instances of the same program. Authority relations are established among processes 33, 35, and 37. Authoritative process 33 has top-level authority in that its data is authoritative and is not conformed to any other data of module 30. Hybrid process 35 is subordinate to authoritative process 33 but is authoritative with respect to conforming process 37. Hybrid process 35 is subordinate in that its data must conform or be conformed to the data of authoritative process 33. Conforming process 37 is at the receiving end of authority relations: its data must conform to that of hybrid process 35; process 37 does not serve as an authoritative process for any other process. Supervisor process 31 sequences activation of processes 33-37 so that authoritative data is available to conforming processes as the latter are activated.

The invention provides for a variety of authority relationships other than and including those in the illustrated embodiments. One authoritative process can provide data to many conforming processes. One conforming process can receive data from many authoritative processes. One process can both provide and receive authoritative data. A pair of processes can both provide and receive authoritative data from each other.

Authority relationships can be fixed or variable in response to information obtained at runtime. Different rationale are available for determining which processes are authoritative. For example, because packets often flow ‘up’ the network stack, the system designer may know that a particular process receives a packet before other processes, and may infer that it is more likely to send its state info to the standby sooner; it has a higher probability of getting across the link before state from another process. Such a process is a good candidate for an authoritative process. Likewise, in some cases, a process may be operating at a higher priority than other processes, and is assured of finishing its activities, which include sending the state info to its peer, before other processes get to run.

In the illustrated embodiment, hybrid processes 25 and 35 are both sources and destinations for authoritative data. In alternative embodiments, each process is either a source or destination (or neither) of authoritative data; no process is both. In some embodiments, the authoritative data provided by an intermediate level to a lower-authority process is a subset of the data it obtained from a higher-authority process. On the other hand, the illustrated embodiments provide for a hybrid process that provides authoritative data that it did not receive as authoritative data.

As indicated very schematically in FIG. 1, during normal device operation, authoritative process 23 locally stores data elements D1-D3, while hybrid process 25 locally stores data elements D4-D6, and conforming process 27 locally stores data elements D7-D9. At steady state, some of these values are constrained by others. For example, data elements D4 and D8 are constrained by D1, D5 is constrained by data element D2, and D9 is constrained by data element D6. Herein, A is “constrained by” B if the set of values that can be assumed by A are a function of the value of B. For example, the constraint may be A=B, or A>B, or something more complex. However, during transitory states, these constraints may be temporarily violated.

During normal device operation, standby authoritative process 33 locally stores data elements E1-E3, standby hybrid process 35 locally stores data elements E4-E6, and standby conforming process 37 locally stores data elements E7-E9. During steady-state conditions, data elements E1-E7 would equal data elements D1-D7 respectively. However, during transient conditions, some of data elements E1-E7 equal their active counterparts, while others may equal predecessor values for those counterparts.

Upon failure of management module 20, there is no reliable way to determine which of data elements E1-E7 represents the most recent value for the corresponding data element D1-D7. Even if all data elements E1-E7 equaled their counterparts, the resulting state might be inconsistent. Thus some effort must be taken to ensure that management module 30 assumes a consistent state when it enters active mode.

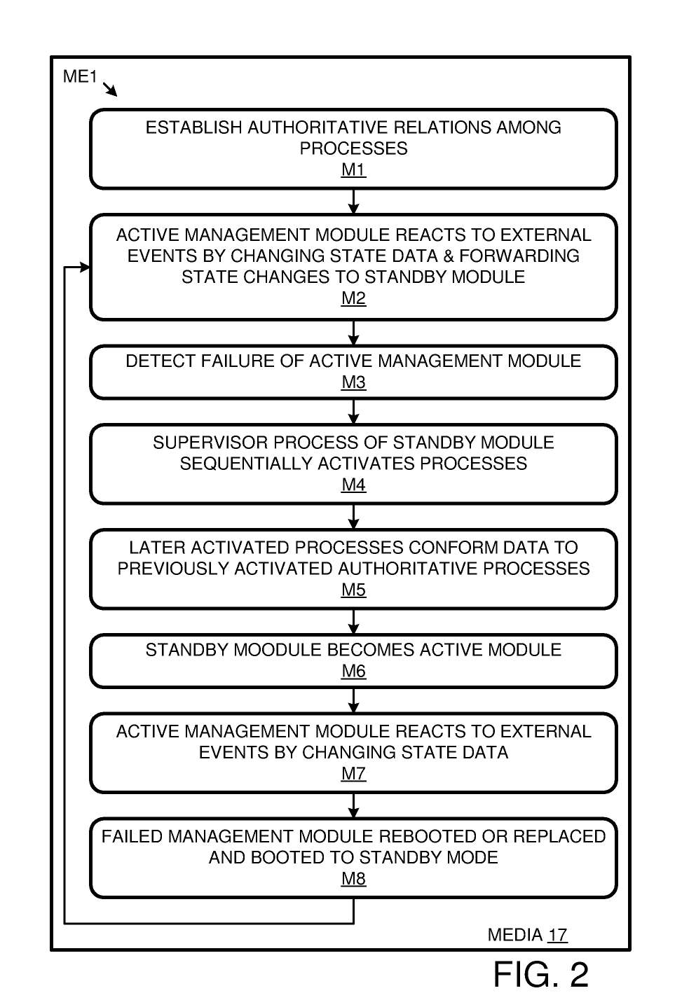

Method ME1, flow charted in FIG. 2, is designed to ensure a standby module assumes a consistent state when it transitions to active mode. Method segment M1 involves establishing authority relations among the processes. This would typically be done as the management modules are programmed, although, in some embodiments, some authority relations can be specified through a configuration routine.

In the simplest instance, a single authoritative process is selected as the source for data for all other processes. For example, if one process stores data that impacts all or most other processes, it could be a good candidate for an authoritative process. Also, a process that needed to be activated first, would be a good candidate for an authoritative process. More complex authoritative hierarchies can be established, such as that shown in FIG. 1. The invention also provides for two-way authoritative relationships, e.g., where a first process conforms to some data of a second process, while the second process conforms to some other data of the first process.

Once the management modules are set up, they operate at method segment M2. The active module responds to events, e.g., protocol-establishing messages, and forwards information required for the standby module to track the state of the active module. The forwarding can be of events from which data is generated or the data itself. Since there is some latency involved in the standby module tracking the active module, there can be some incoherence between modules as an event is being processed when a failure event is detected at method segment M3.

In response to detection of a failure of the active module, the supervisor process (e.g., 31) for the standby module (e.g., 30) begins to transition its module to active mode. Typically, processes are activated sequentially at method segment M4. At overlapping method segment M5, conforming processes, which tend to be activated later than authoritative processes, conform their data to authoritative processes.

Thus, as module 30 is transitioned to active mode, supervisor process 31 activates authoritative process 33 first. Then, as hybrid process 35 is activated, data E4 is conformed to data E1, and data E5 is conformed to data E2. Conforming can be implemented in a variety of ways: 1) the conforming process can actively retrieve the conforming data; 2) an authoritative process can impose its data on a conforming process; and 3) a third process, e.g., supervisor process 31, can be responsible for conforming. When conforming process 37 is activated, data E8 is conformed to data E2, and data E9 is conformed to data E6. Note that, because of the hierarchical authority relations, data element E9 can be conformed to data not represented in top-level authoritative process 33. FIG. 1 depicts conforming as though the constraint were equality. However, the invention provides for conforming to a full range of logico-mathematical constraints.

Once the activation of processes and data conforming is complete, former standby management module 30 becomes the active management module at method segment M6. As the active management module, it can begin reacting to external events and generating outgoing events at method segment M7. In the meantime, the failed management module can be addressed at method segment M8. Often, a failed module only requires rebooting. In other cases, the failed module may need a software update. In still other cases, the module may need to be physically replaced. In all of these cases, there is a reboot to a standby state. At that point, method ME1 returns to method segment M2; in this iteration, the active and standby roles are reversed.

While the illustrated device is a network switch, the invention can apply to other devices with state-tracking standby modules provided there are steady-state internal consistency rules for conforming data. In some cases, these rules can provide for reconstructing a state of the formerly active module; in other cases, the invention provides a useful albeit inexact copy of the state of the formerly active module. In some cases the inaccuracies may be unimportant—e.g., in view of the resilience of network protocols to communications errors. These and other variations upon and modifications to the illustrated embodiments are provided for by the present invention, the scope of which is defined by the following claims.

What is claimed is:

1. A method comprising:
detecting a failure in an active first instance of a computer-executable manager of and for a device; and
activating processes of a second instance of said manager so that at least a conforming first process of said second instance conforms to state data of an authoritative second process of said second instance.

2. A method as recited in claim 1 further comprising:
establishing authoritative relationships among processes of a manager for said device;
managing a network switch using an active first instance of said manager while having a standby second instance of said manager asynchronously track the state of said first instance; and
after said activating, having said second instance manage said network switch.

3. A method as recited in claim 2 further comprising:
having said first instance track said second instance.

4. A method as recited in claim 3 further comprising rebooting said first instance prior to said first instance tracking said second instance.

5. A method as recited in claim 2 wherein said activating further involves having a conforming third process of said second instance conform to said first process.

6. A method as recited in claim 2 wherein said activating further involves having a conforming third process of said second instance conform to said second process.

7. A method as recited in claim 2 wherein said conforming of said third process involves conforming to data of said first process not changed by said first process conforming to said second process.

8. A device comprising:
configurable hardware;
first and second instances of a computer-executable manager for said hardware, each of said instances supporting plural processes for manipulating state data for said hardware, each of said instances being able to assume an active mode and a tracking standby mode whereby an instance in said active mode interacts with external devices and an active instance in said tracking standby mode tracks the state data of said instance in said active mode, the processes in a instance in said active mode having consistency rules that apply when said instance is in a steady state, each of said instances modifying tracked data to conform to said consistency rules when transitioning from said tracking standby mode to said active mode.

9. A device as recited in claim 8 wherein said device is a network switch.

10. A device as recited in claim 8 wherein said second instance has a first process with state data that is conformed to state data for a second process which in turn has state data that is conformed to state data for a third process as said second instances transitions from said tracking standby mode to said active mode.

11. A device as recited in claim 10 wherein said second instance has a third process with state data that is conformed to said state data for said second process as said second instances transitions from said tracking standby mode to said active mode.

12. A device as recited in claim 10 wherein said second instance has a third process with state data that is conformed to said state data for said first process as said second instances transitions from said tracking standby mode to said active mode.

13. A device as recited in claim 12 wherein some of said state data for said third process is conformed to state data for said second process as said second instances transitions from said tracking standby mode to said active mode.

14. A device as recited in claim 10 wherein said first process conforms state data to a third process as said second instances transitions from said tracking standby mode to said active mode.

15. Computer-readable media comprising a program of computer-executable instructions providing for:
a device manager providing for a first process and a second process, said device manager providing for an active mode and a tracking standby mode, said device manager while in said active mode alternating between steady states and transitional states during which said device manager responds to external events, said first and second processes modifying respective first and second sets of data so that that they conform to consistency rules while said device manager is in said steady states, said device manager while in said tracking standby mode conforming said first and second sets of data with data of an active second instance of said device manager, said device manager modifying said first set of data at least in part as a function of said second set of data to conform to said consistency rules while transitioning from said tracking standby mode to said active mode.

16. Media as recited in claim 15 wherein said device manager provides for modifying said second set of data at least in part as a function of first set of data to conform to said consistency rules.

17. Media as recited in claim 15 wherein said device manager provides for a third process for modifying a respective third set of data, said device manager modifying said third set of data as a function of said second set of data to conform to said consistency rules.

18. Media as recited in claim 15 wherein said device manager provides for a third process for modifying a respective third set of data, said device manager modifying said third set of data at least in part as a function of said first set of data to conform to said consistency rules.

19. Media as recited in claim 15 wherein said device manager provides for a third process for modifying a respective third set of data, said device manager modifying said first set of data at least in part as a function of said third set of data to conform to said consistency rules.

20. Media as recited in claim 15 wherein said first set of data includes configuration data for a network switch.
